(19) United States
(12) Patent Application Publication
(10) Pub. No.: US 2017/0215480 A1
(43) Pub. Date: Aug. 3, 2017

(54) POWER SUPPLY DEVICE, AEROSOL GENERATING DEVICE, AND IDENTIFYING AND CONTROLLING METHOD FOR AEROSOL GENERATING DEVICE

(71) Applicant: CHANGZHOU JWEI INTELLIGENT TECHNOLOGY CO., LTD., Changzhou (CN)

(72) Inventor: WEI-HUA QIU, ChangZhou (CN)

(21) Appl. No.: 15/484,078

(22) Filed: Apr. 10, 2017

Related U.S. Application Data
(63) Continuation-in-part of application No. PCT/CN2016/086298, filed on Jun. 17, 2016.

(30) Foreign Application Priority Data
Jul. 2, 2015 (CN) 201510381431.1
Jul. 2, 2015 (CN) 201510381948.0

(51) Int. Cl. A24F 47/00; H05B 1/02; G06F 1/26

(52) U.S. Cl. CPC A24F 47/008; G06F 1/266; H05B 1/0244

(57) ABSTRACT

A power supply device includes at least one processor and a memory coupled to the at least one processor The memory stores programs which cause the at least one processor to collect identification information of an identifier, decode and convert the collected identification information into machine readable form, determine whether there is a set of standard identification information which matches the identification information in machine readable form, and output a control signal according to a working mode of an atomizer corresponding to the set of standard identification information. An aerosol generating device and an identifying and controlling method for the aerosol generating device are further provided.

### CROSS-REFERENCE TO RELATED APPLICATIONS

This application claims all benefits accruing under 35 U.S.C. §119 from China Patent Application No. 201510381431.1, filed on Jul. 2, 2015 in the China Intellectual Property Office, and from China Patent Application No. 201510381948.0, filed on Jul. 2, 2015 in the China Intellectual Property Office, the content of which is hereby incorporated by reference. This application is a continuation-in-part under 35 U.S.C. §120 of international patent application PCT/CN2016/086298 filed Jun. 17, 2016.

### FIELD

The subject matter relates to electronic cigarettes, and more particularly, to a power supply device, an aerosol generating device, and an identifying and controlling method for the aerosol generating device.

### BACKGROUND

Existing aerosol generating devices comprise atomizers and power supply devices electrically connected to the atomizers. When an aerosol generating device is working, the power supply device supplies power to the atomizer, thereby causing the atomizer to heat aerosol-forming material to generate smoke, thus bringing a smoking experience to a user. However, since the type and/or model of the atomizer may be different, the working mode of the atomizer may also be different. The user needs to first operate and get to know the properties of the atomizer, for example, whether the atomizer has a temperature controlling function, the way of the atomizer achieving temperature control, the type and/or model of a heat generating element of the atomizer, before the user determines the best working mode of the atomizer. The operation process may be cumbersome which decreases the user experience.

### BRIEF DESCRIPTION OF THE DRAWINGS

FIG. 1 is a block diagram of an embodiment of an aerosol generating device.

FIG. 2 is a flowchart of a first embodiment of an identifying and controlling method for an aerosol generating device.

FIG. 3 is a flowchart of a second embodiment of an identifying and controlling method for an aerosol generating device.

FIG. 4 is a flowchart of a third embodiment of an identifying and controlling method for an aerosol generating device.

FIG. 5 is a flowchart of a fourth embodiment of an identifying and controlling method for an aerosol generating device.

### DETAILED DESCRIPTION

The present disclosure, including the accompanying drawings, is illustrated by way of examples and not by way of limitation.

In general, the word “module,” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprise connected logic modules, such as gates and flip-flops, and may comprise programmable modules, such as programmable gate arrays or processors. The modules described herein may be implemented as either software and/or hardware modules and may be stored in any type of non-transitory computer-readable storage medium or other computer storage device. The term “comprising,” when utilized, means “including, but not necessarily limited to”; it specifically indicates open-ended inclusion or membership in the so-described combination, group, series, and the like.

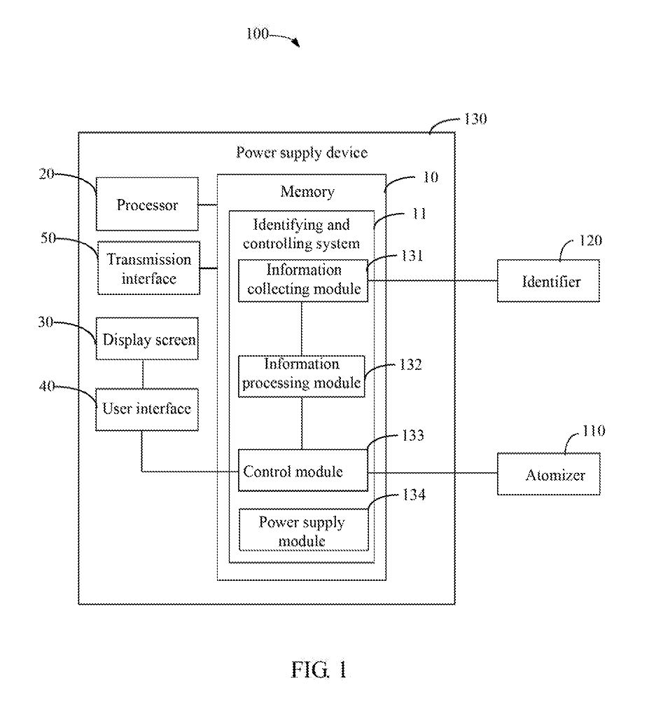

FIG. 1 illustrates an aerosol generating device 100. The elements comprised in the aerosol generating device 100 are not drawn to scale, and some irrelevant elements are omitted for simplicity.

The aerosol generating device 100 comprises an atomizer 110 and a power supply device 130. The atomizer 110 atomizes aerosol-forming material. The power supply device 130 is electrically connected to and supplies power to the atomizer 110. The power supply device 130 further collects, converts, analyzes, processes and stores identification information indicated by an identifier 120, and controls the aerosol generating device 100 to run normally.

The identifier 120 indicates the identification information.

The identification information indicated by the identifier 120 comprises code of the working mode of the atomizer 110, type and/or model, manufacturer and/or wholesaler, batch number, production date, and service life of the atomizer 110, type and/or model of the aerosol-forming material capable of being atomized by the atomizer 110, type and/or model of a heat generating element (not shown) of the atomizer 110, type and/or model of a temperature sensing element (not shown) of the atomizer 110, or any combination thereof. The code of the working mode of the atomizer 110 is in a form of pattern, character, number, letter, or any combination thereof. One code represents one working mode of the atomizer 110. The identifier 120 is positioned on the atomizer 110, package/specification of the atomizer 110/aerosol generating device 100/aerosol-forming material, or card/sales website/electronic document corresponding to the atomizer 110/aerosol generating device 100/aerosol-forming material.

The identifier 120 is in a formed of pattern, character, number, letter, one-dimensional bar code, two-dimensional bar code, three-dimensional bar code, magnetic tag, electronic tag, or any combination thereof.

The identifier 120 is formed by a printing, surface treatment, gluing, inlaying, editing, or any combination thereof. The printing can be performed by ink and/or carbon dust. The surface treatment can be performed on surface of the atomizer 110, the package of the atomizer 110/aerosol generating device 100/aerosol-forming material, at least one page of the specification of the atomizer 110/aerosol generating device 100/aerosol-forming material, or the card corresponding to the atomizer 110/aerosol generating device 100/aerosol-forming material, to form recesses, protrusions, and/or cutouts.

The power supply device 130 comprises a memory 10 and at least one processor 20. The memory 10 stores an identifying and controlling system 11. The identifying and controlling system 11 comprises an information collecting module 131, an information processing module 132, a control module 133, and a power supply module 134. The information processing module 132 is electrically connected to the control module 133 and the information collecting module 131. The control module 133 is electrically connected to the atomizer 110. The power supply module 134 is electrically connected to a battery (not shown) of the power supply device 130. The modules 131-134 may comprise computerized instructions in the form of one or more programs that are stored in the memory 10 and executed by the at least one processor 20. A detailed description of each module will be given in the following paragraphs.

The information collecting module 131 collects the identification information of the identifier 120. The identification information can be collected by scanning, be received through a wireless/wired port, or as user input.

The information processing module 132 decodes the collected identification information from the information collecting module 131 and converts the decoded identification information to machine readable data information.

The control module 133 controls the power supply device 130 to work, coordinates all modules of the power supply device 130 to work with each other, and controls the aerosol generating device 100 to run normally. The control module 133 further determines whether there is a set of standard identification information matching the machine readable data information, and outputs a control signal according to a working mode of the atomizer 110 corresponding to the set of standard identification information. The control signal is configured to control the aerosol generating device 100 to work in the working mode corresponding to the set of standard identification information, thereby atomizing the aerosol-forming material.

The memory 10 further stores data information and/or software. The data information can be the machine readable data information converted by the information processing module 132, and also can be the standard identification information of the atomizer 110. The software can be the working mode of the atomizer 110 corresponding to the standard identification information. In this embodiment, the memory 10 pre-stores at least one set of standard identification information and at least one working mode of the atomizer 110 corresponding to the set of standard identification information. The working mode can comprise a temperature controlling mode and a voltage/power controlling mode. The temperature controlling mode can be divided into four types, according to different ways to achieve temperature control. The first type of the temperature controlling mode is calculating the temperature of the heat generating element by detecting relevant physical values of the temperature sensing element, and adjusting output voltage/output power according to the calculated temperature, thereby achieving temperature control. The second type of the temperature controlling mode is connecting the power supply device 130 or disconnecting the power supply device 130 to the atomizer 110 through a temperature detection switch, thereby achieving temperature control. The third type of the temperature controlling mode is determining the temperature of the heat generating element by detecting actions of the temperature detection switch, and adjusting output voltage/output power according to the determined temperature, thereby achieving temperature control. The fourth type of the temperature controlling mode is calculating the temperature of the heat generating element having temperature coefficient of resistance characteristics by detecting a resistance value of the heat generating element, and adjusting output voltage/output power according to the calculated temperature, thereby achieving temperature control. Such four ways to achieve temperature control are known in the art, such as the subject matter of CN Patent Application Publication No. 201510054274.3, 201520072802.3, 201510059426.9, 201520072776.4, 201510059433.9, 201520073371.2, and 201510054625.0. In other embodiments, the temperature controlling mode is not limited to the above four types and can be varied according to need.

The power supply module 134 controls the battery to supply power to the atomizer 110.

Furthermore, the power supply device 130 further comprises a display screen 30. The display screen 30 displays content comprising menu of the aerosol generating device 100, indication/warning for operating the aerosol generating device 100, the working modes of the atomizer 110, the working parameters of the aerosol generating device 100, or any combination thereof, thereby indicating to the user a working state of the aerosol generating device 100.

In other embodiments, the display screen 30 can be replaced by at least one indicating lamp. The indicating lamp can indicate the content through pattern, character, number, or letter formed by the one or more indicating lamps, different colors of the indicating lamps, different numbers of the indicating lamps which are turned on/off, or any combination thereof, thereby indicating to the user the working state of the aerosol generating device 100.

In other embodiments, the display screen 30 can be replaced by a loudspeaker which audibly indicates the content, thereby indicating to the user the working state of the aerosol generating device 100.

Furthermore, the power supply device 130 further comprises a user interface 40 electrically connected to the display screen 30 and the control module 133. The user interface 40 generates input signals in response to operations to the displayed content on the display screen 30, and transmits the input signals to the control module 133. In this embodiment, the input signal comprises selecting the working mode of the atomizer 110 and setting the working parameters of the aerosol generating device 100. That is, the control unit 133 controls the aerosol generating device 100 to work in the selected working mode of the atomizer 110, to work based on the set working parameters, or any combination thereof. The working parameters comprise output voltage/output power of the battery, working temperature of the atomizer 110, working duration of the atomizer 110, and puff number of the aerosol generating device 100, or any combination thereof.

Furthermore, when there are at least two working modes corresponding to the standard identification information, and/or when there is at least one working parameter which is user-adjustable for the working mode corresponding to the standard identification information, the user may have preferences for the working mode and/or the working parameters. Then, the user can select the working mode and/or set the working parameters according to his or her preferences through the user interface 40 as default which is stored in the memory 10. When the user uses the atomizer 110 or another same-model atomizer later, the user can call the default working mode and/or working parameters from the memory 10. For example, the user can select the temperature controlling mode among some user-adjustable working modes and the working temperature of 300 degrees Celsius among some user-adjustable working parameters as default for the atomizer 110, and store them in the memory 10. When the user uses the atomizer 110 or another same-model atomizer later, if the user selects the default working mode and default working parameters, the atomizer 110 or the same-model atomizer instantly works in the temperature controlling mode and the working temperature of 300 degrees Celsius, thereby saving setup time and improving the user experience.

In other embodiments, the default working mode and/or working parameters can be provided by the manufacturer and pre-stored in the memory 10. The user can personally change the default working mode and/or working parameters provided by the manufacturer.

Furthermore, the power supply device 130 further comprises a transmission interface 50 electrically connected to the memory 10. The transmission interface 50 can be connected to other equipment via a wireless/wired port, and introduce the data information and/or software from the other equipment into the memory 10 for updating and/or enriching the memory 10, or introduce the data information and/or software from the memory 10 into the other equipment, for use and analysis by the other equipment. The other equipment comprises another power supply device, computer, special data analyzing and processing equipment, service system provided by the manufacturer, or any combination thereof.

In other embodiments, the transmission interface 50 is electrically connected to the control module 133. The at least one set of standard identification information and at least one working mode corresponding to the set of standard identification information are stored in the other equipment. The transmission interface 50 is connected to the other equipment via a wireless/wired port, thereby allowing the control module 133 to obtain the at least one set of standard identification information and the at least one working mode corresponding to the set of standard identification information in real-time from the other equipment.

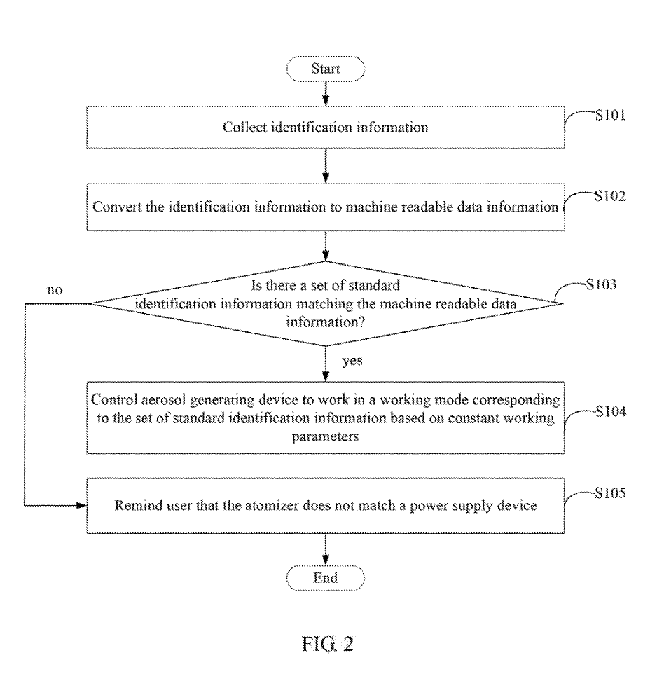

FIG. 2 illustrates an identifying and controlling method for the aerosol generating device 100, in a situation where the memory 10 or other equipment stores at least one set of standard identification information, there is only one working mode corresponding to each set of standard identification information, and the working parameters for each working mode are constant and non-adjustable.

At step S101, the information collecting module 131 collects identification information of the identifier 120. Then the procedure goes to step S102.

Step S102, the information processing module 132 decodes the collected identification information from the information collecting module 131 and converts the decoded identification information to machine readable data information. Then the procedure goes to step S103.

Step S103, the control module 133 determines whether there is a set of standard identification information matching the machine readable data information. If yes, the procedure goes to step S104, otherwise the procedure goes to step S105.

Step S104, the control module 133 controls the aerosol generating device 100 to work in the working mode corresponding to the set of standard identification information based on the constant working parameters.

Step S105, the control module 133 reminds the user that the atomizer 110 connected to the power supply device 130 does not match the power supply device 130.

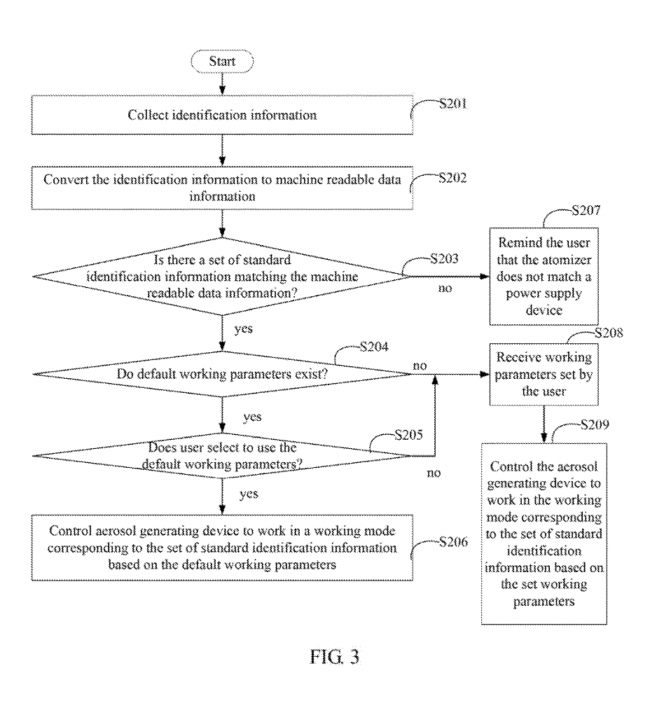

FIG. 3 illustrates an identifying and controlling method for the aerosol generating device 100, in a situation where the memory 10 or other equipment stores at least one set of standard identification information, there is only one working mode corresponding to each set of standard identification information, and at least one working parameter for each working mode is adjustable:

At step S201, the information collecting module 131 collects identification information of the identifier 120. Then the procedure goes to step S202.

Step S202, the information processing module 132 decodes the collected identification information from the information collecting module 131 and converts the decoded identification information to machine readable data information. Then the procedure goes to step S203.

Step S203, the control module 133 determines whether there is a set of standard identification information matching the machine readable data information. If yes, the procedure goes to step S204, otherwise the procedure goes to step S207.

Step S204, the control module 133 determines whether default working parameters exist. If yes, the procedure goes to step S205, otherwise the procedure goes to step S208.

Step S205, the control module 133 determines whether the user selects to use the default working parameters according to input signals from the user interface 40. If yes, the procedure goes to step S206, otherwise the procedure goes to step S208.

Step S206, the control module 133 controls the aerosol generating device 100 to work in the working mode corresponding to the set of standard identification information based on the default working parameters.

Step S207, the control module 133 reminds the user that the atomizer 110 connected to the power supply device 130 does not match the power supply device 130.

Step S208, the control module 133 receives working parameters set by the user according to input signals from the user interface 40. Then the procedure goes to step S209.

Step S209, the control module 133 controls the aerosol generating device 100 to work in the working mode corresponding to the set of standard identification information based on the set working parameters.

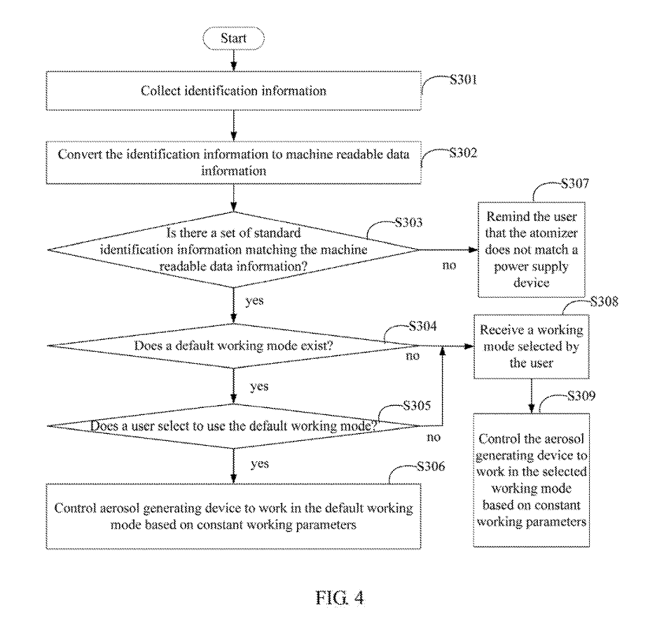

FIG. 4 illustrates an identifying and controlling method for the aerosol generating device 100, in a situation where the memory 10 or other equipment stores at least one set of standard identification information, there are at least two working modes corresponding to each set of standard identification information, and the working parameters for each working mode are constant and non-adjustable.

At step S301, the information collecting module 131 collects identification information of the identifier 120. Then the procedure goes to step S302.

Step S302, the information processing module 132 decodes the collected identification information from the information collecting module 131 and converts the decoded identification information to machine readable data information. Then the procedure goes to step S303.

Step S303, the control module 133 determines whether there is a set of standard identification information matching the machine readable data information. If yes, the procedure goes to step S304, otherwise the procedure goes to step S307.

Step S304, the control module 133 determines whether a default working mode exists. If yes, the procedure goes to step S305, otherwise the procedure goes to step S308.

Step S305, the control module 133 determines whether the user selects to use the default working mode according to input signals from the user interface 40. If yes, the procedure goes to step S306, otherwise the procedure goes to step S308.

Step S306, the control module 133 controls the aerosol generating device 100 to work in the default working mode based on the constant working parameters.

Step S307, the control module 133 reminds the user that the atomizer 110 connected to the power supply device 130 does not match the power supply device 130.

Step S308, the control module 133 receives a working mode selected by the user according to input signals from the user interface 40. Then the procedure goes to step S309.

Step S309, the control module 133 controls the aerosol generating device 100 to work in the selected working mode based on the constant working parameters.

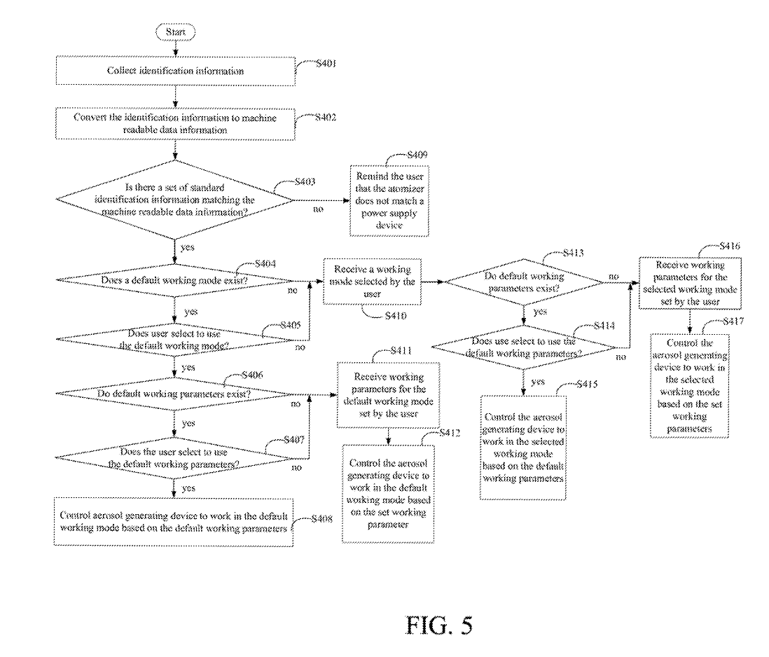

FIG. 5 illustrates an identifying and controlling method for the aerosol generating device 100, in a situation where the memory 10 or other equipment stores at least one set of standard identification information, there are at least two working modes which correspond to each set of standard identification information, and at least one working parameter for each working mode is adjustable.

At step S401, the information collecting module 131 collects identification information of the identifier 120. Then the procedure goes to step S402.

Step S402, the information processing module 132 decodes the collected identification information from the information collecting module 131 and converts the decoded identification information to machine readable data information. Then the procedure goes to step S403.

Step S403, the control module 133 determines whether there is a set of standard identification information matching the machine readable data information. If yes, the procedure goes to step S404, otherwise the procedure goes to step S409.

Step S404, the control module 133 determines whether a default working mode exists. If yes, the procedure goes to step S405, otherwise the procedure goes to step S410.

Step S405, the control module 133 determines whether the user selects to use the default working mode according to input signals from the user interface 40. If yes, the procedure goes to step S406, otherwise the procedure goes to step S410.

Step S406, the control module 133 determines whether default working parameters for the default working mode exist. If yes, the procedure goes to step S407, otherwise the procedure goes to step S411.

Step S407, the control module 133 determines whether the user selects to use the default working parameters for the default working mode according to input signals from the user interface 40. If yes, the procedure goes to step S408, otherwise the procedure goes to step S411.

Step S408, the control module 133 controls the aerosol generating device 100 to work in the default working mode based on the default working parameters.

Step S409, the control module 133 reminds the user that the atomizer 110 connected to the power supply device 130 does not match the power supply device 130.

Step S410, the control module 133 receives a working mode selected by the user according to input signals from the user interface 40. Then the procedure goes to step S413.

Step S411, the control module 133 receives working parameters for the default working mode set by the user according to input signals from the user interface 40. Then the procedure goes to step S412.

Step S412, the control module 133 controls the aerosol generating device 100 to work in the default working mode based on the set working parameters.

Step S413, the control module 133 determines whether default working parameters exist for the selected working mode. If yes, the procedure goes to step S414, otherwise the procedure goes to step S416.

Step S414, the control module 133 determines whether the user selects to use the default working parameters for the selected working mode according to input signals from the user interface 40. If yes, the procedure goes to step S415, otherwise the procedure goes to step S416.

Step S415, the control module 133 controls the aerosol generating device 100 to work in the selected working mode based on the default working parameters.

Step S416, the control module 133 receives working parameters for the selected working mode set by the user according to input signals from the user interface 40. Then the procedure goes to step S417.

Step S417, the control module 133 controls the aerosol generating device 100 to work in the selected working mode based on the set working parameters.

In other embodiments, when the memory 10 or other equipment stores at least one set of standard identification information, there is at least one working mode corresponding to each set of standard identification information, the working parameters for a portion of the working modes are constant and non-adjustable, and at least one working parameter for the other portion of the working modes is adjustable, the identifying and controlling method for the aerosol generating device 100 can be combined by and/or modified according to the identifying and controlling methods, or elements of them, of the above embodiments.

The aerosol generating device 100 has the following advantages.

(1) The power supply device 130 obtains the identification information through the identifier 120, and can quickly call the corresponding working mode of the atomizer 110 according to the identification information. The user therefore does not need to operate the atomizer 110 to get to know the properties of the atomizer 110, for example, whether the atomizer 110 has a temperature controlling function, the way of the atomizer achieving temperature control, the type and/or model of the heat generating element of the atomizer 110. The likelihood of operating the aerosol generating device 100 in an improper working mode, which may cause damage to the user or the aerosol generating device 100, is reduced. Misunderstandings as to the detail information of the atomizer 110 are also less likely. As such, the safety in operation is improved.

(2) The power supply device 130 only supplies certain power to an atomizer 110 matching the power supply device 130, thereby improving safety in operation. The power supply device 130 cooperatively works with a matching atomizer 110, thereby improving the working efficiency and increasing the service life of the power supply device 130 and the atomizer 110.

(3) The user can set preferences for using the atomizer 110 as default which are stored in the memory 10. When the user uses the atomizer 110 or another same-model atomizer later, the user can recall the default working mode and/or the default working parameters from the memory 10, thereby improving the user experience.

(4) The transmission interface 50 can be connected to other equipment via a wireless/wired port, and introduce data information and/or software from the other equipment into the memory 10 for updating and/or enriching the memory 10. This is advantageous to update the power supply device 130.

(5) The transmission interface 50 can be connected to other equipment via a wireless/wired port, and introduce data information and/or software from the memory 10 into the other equipment, for use and analysis by the other equipment. This is advantageous when changing to another atomizer 110 and/or power supply device 130, and allows the manufacturer to collect and analyze user preferences and data as to the authenticity and performance of their own goods.

(6) The transmission interface 50 can be connected to other equipment, thereby allowing the control module 133 to obtain at least one set of standard identification information and at least one working mode of an atomizer 110 corresponding to the set of standard identification information, in real-time from the other equipment. Thus, the memory 10 does not need to store the at least one set of standard identification information and the at least one working mode of an atomizer 110 corresponding to the set of standard identification information, thereby easing the memory burden of the aerosol generating device 100.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A power supply device comprising:
at least one processor; and
a memory coupled to the at least one processor and configured to store one or more programs, which when executed by the at least one processor, cause the at least one processor to:
collect identification information of an identifier;
decode the collected identification information and convert the decoded identification information to machine readable data information;
determine whether there is a set of standard identification information matching the machine readable data information, if there is a set of standard identification information, output a control signal according to a working mode of an atomizer corresponding to the set of standard identification information.

2. The power supply device of claim 1, wherein the memory further stores data information comprising at least one set of standard identification information, and software comprising at least one working mode corresponding to the set of standard identification information.

3. The power supply device of claim 1, further comprising a display screen, wherein the display screen is configured to display content comprising menu of an aerosol generating device, indication and/or warning for operating the aerosol generating device, working modes, working parameters of the aerosol generating device, or any combination thereof.

4. The power supply device of claim 3, further comprising a user interface, wherein the user interface is configured to generate input signals in response to operations to the displayed content on the display screen, the input signal comprises selecting the working mode of the atomizer and setting the working parameters of the aerosol generating device.

5. The power supply device of claim 2, further comprising a transmission interface, wherein the transmission interface is connected to an other equipment via a wireless/wired port, and is configured to introduce data information and/or software from the other equipment into the memory, introduce the data information and/or software from the memory into the other equipment, or allow the one or more programs to obtain the at least one set of standard identification information and the at least one working mode corresponding to the set of standard identification information in real-time from the other equipment.

6. The power supply device of claim 1, wherein the identification information indicated by the identifier comprises code of working mode of the atomizer, type and/or model, manufacturer and/or wholesaler, batch number, production date, and service life of the atomizer, type and/or model of aerosol-forming material capable of being atomized by the atomizer, type and/or model of a heat generating element of the atomizer, type and/or model of a temperature sensing element of the atomizer, or any combination thereof.

7. The power supply device of claim 1, wherein the identifier is positioned on the atomizer, package/specification of the atomizer/aerosol generating device/aerosol-forming material, or card/sales website/electronic document corresponding to the atomizer/aerosol generating device/aerosol-forming material.

8. The power supply device of claim 1, wherein the identifier is in a formed of pattern, character, number, letter, one-dimensional bar code, two-dimensional bar code, three-dimensional bar code, magnetic tag, electronic tag, or any combination thereof.

9. The power supply device of claim 8, wherein the identifier is formed by printing, surface treatment, gluing, inlaying, editing, or any combination thereof.

10. An aerosol generating device comprising:
an atomizer for atomizing aerosol-forming material; and
a power supply device comprising:
at least one processor; and
a memory coupled to the at least one processor and configured to store one or more programs, which when executed by the at least one processor, cause the at least one processor to:
collect identification information of an identifier;
decode the collected identification information and convert the decoded identification information to machine readable data information;
determine whether there is a set of standard identification information matching the machine readable data information, and output a control signal according to a working mode of the atomizer corresponding to the set of standard identification information.

11. The aerosol generating device of claim 10, wherein the memory further stores data information comprising at least one set of standard identification information, and software comprising at least one working mode corresponding to the set of standard identification information.

12. An identifying and controlling method for an aerosol generating device, the aerosol generating device comprising an atomizer and a power supply device connected to the atomizer, the identifying and controlling method comprising:
collecting identification information of an identifier;
decoding the collected identification information and translating the decoded identification information to machine readable data information;
determining whether there is a set of standard identification information matching the machine readable data information;
outputting a control signal according to a working mode of the atomizer corresponding to the set of standard identification information; and
reminding a user that the atomizer connected to the power supply device does not match the power supply device when no set of standard identification information matches the machine readable data information.

13. The identifying and controlling method of claim 12, wherein the step of outputting a control signal according to a working mode of the atomizer corresponding to the set of standard identification information further comprises:
when there is only one working mode corresponding to the set of standard identification information, controlling the aerosol generating device to work in the corresponding working mode;
when there are at least two working modes corresponding to the set of standard identification information, determining whether a default working mode exists.

14. The identifying and controlling method of claim 13, further comprising:
determining whether the user selects to use the default working mode when the default working mode exists;
receiving a working mode selected by the user when no default working mode exists; and
controlling the aerosol generating device to work in the selected working mode.

15. The identifying and controlling method of claim 14, further comprising:
controlling the aerosol generating device to work in the default working mode when the user selects to use the default working mode;
receiving a working mode selected by the user when the user selects not to use the default working mode; and
controlling the aerosol generating device to work in the selected working mode.

16. The identifying and controlling method of claim 13, wherein the step of controlling the aerosol generating device to work in the corresponding working mode further comprises:
when working parameters for the corresponding working mode are constant, controlling the aerosol generating device to work in the corresponding working mode based on the constant working parameters; and
when at least one of the working parameters for the corresponding working mode is adjustable, determining whether default working parameters exist.

17. The identifying and controlling method of claim 16, further comprising:
determining whether the user selects to use the default working parameters when the default working parameters exist;
receiving working parameters set by the user when no default working parameters exist; and
controlling the aerosol generating device to work in the corresponding working mode based on the set working parameters.

18. The identifying and controlling method of claim 17, further comprising:
controlling the aerosol generating device to work in the corresponding working mode based on the default working parameters when the user selects to use the default working parameters;
receiving working parameters set by the user when the user selects not to use the default working parameters; and
controlling the aerosol generating device to work in the corresponding working mode based on the set working parameters.
